(19) United States
(12) Patent Application Publication
(10) Pub. No.: US 2002/0192385 A1
(43) Pub. Date: Dec. 19, 2002

(54) Method of applying a fluoroalkyl-functional organopolysiloxane coationg having durable water and oil repellent properties to polymeric substrates

(75) Inventors: Peter Jenkner, Rheinfelden (DE); Eckhard Just, Rheinfelden (DE); Markus Oles, Hattingen (DE); Bernhard Schleich, Recklinghausen (DE); Peter Hommes, Zell am Main (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: DEGUSSA AG, Duesseldorf (DE)

(21) Appl. No.: 10/035,206

(22) Filed: Jan. 4, 2002

(30) Foreign Application Priority Data
Jan. 5, 2001 (DE) 101 00 383.8

(51) Int. Cl. B05D 3/06; B05D 3/02

(52) U.S. Cl. 427/387; 427/532; 427/536; 427/551

(57) ABSTRACT

Polymeric substrate are coated by a process comprising pretreating the polymeric substrate by at least one physical method selected from the group consisting of corona discharge, flaming, glow discharge, irradiation with electromagnetic waves, and a plasma pretreatment, then coating the pretreated polymeric substrate with a composition comprising a fluoroalkyl-containing silicon compound. The resulting coated is very thin, highly hydrophobic and oleophobic. The coatings prepared by the process of the present invention are stable in boiling water and are resistant to abrasion.

### BACKGROUND OF THE INVENTION

The present invention relates to a method of coating a polymeric substrate with an organosilicon compound in which the surface of the substrate is physically pretreated prior to coating. The present invention further relates to oil, water and dirt repellent coatings and coated substrates and the corresponding coated articles.

Hydrophobic and oleophobic surfaces are much in demand for industrial processes and everyday objects, for example, because such surfaces are water repellent, as in plastic covers and viewing windows. However, it may also be desirable to prevent the adhesion of, for example, particles of dirt, foods, microorganisms, paints, inks, resins or adhesives on such surfaces. This imposes additional requirements on such coatings. The coating may be required, for example, to adhere well itself, to be mechanically stable, to possess optical transparency, to exhibit only minimal flexibility, and form an impervious covering over the substrate down to even the nanometer scale. If the surface texture of the substrate must be maintained after the surface is made hydrophobic (i.e., by coating), the maximun thickness of the coating is limited to 1% of the size of the texture features.

There are numerous approaches known in the scientific literature for tackling such problems, for example using silanes and fluorine compounds and, where appropriate, by the use of physical methods.

A simple procedure for combining the interface properties of a low energy surface with the material properties of a conventional semi-finished product is to laminate fluoropolymers onto semi-finished products made of polymethyl methacrylate (PMMA) or polycarbonate (PC) (e.g., as described in JP 09-316830). The fluoropolymer cover sheet imparts the desired interface properties but leads to reduced light transmission. A considerable disadvantage of this method is that it can only be used for planar objects and such fluorocarbon films reproduce only very coarse surface textures.

Thinner organofluorine polymer films may be provided by coating the substrate with layers of the polymer dissolved in solution. For such coatings, it is common to use silanes as adhesion promoters between the substrate and the coating layers. For example, polymeric substrates may be first treated with 3-aminopropyltriethoxysilane, after which a solution containing fluoropolymers, such as vinylidene fluoride copolymers (e.g., as described in JP 08-277379) or poly(perfluorobutenyl vinyl ether) (e.g., as described in JP 04-326965) is applied. Depending on the procedure used, and the presence of additional components in the film, the resulting coating may be, for example, an extremely hard, scratch resistant, firmly adhering and dirt repellent coating. The procedure is, however, complex, since in the processes described above, it is necessary to apply a plurality of components, in succession, in a plurality of steps. Due to interface effects, when polymer films dry on textured surfaces, wetting problems may result. For example, elevated portions of the textured surface may remain uncoated, and depressed portions of the surface (i.e., “valleys”) are “leveled out”—that is, they are partially filled in by the coating. As a result, the texture of the surface may become partially obliterated.

In other processes, “paint-like” coating systems may also be used, which are subsequently modified with fluoroalkyltrialkoxysilanes in order to reduce the surface energy of the coating. In order to firmly attach the corresponding organofluorosilanes, the substrate surface may be first covered with metal oxides (e.g., as described in JP 01-110588 and JP 07-238229). These oxides may be, for example, Al₂O₃, ZrO₂ or SiO₂. The substrate surface may be covered with an oxide by adding tetramethoxysilane to an acrylic urethane varnish which is cured by UV treatment. A post-treatment, for example with perfluorooctylethylenetrimethoxysilanes, condenses the metal oxide unit and the alkoxysilane unit, forming covalent bonds between the silane and the metal oxide. In this way it is possible to generate scratch resistant, dirt repellent surfaces having a contact angle which is approximately 100 to 110° and which decreases by about 9° after the surface has been wiped twenty times with a cloth.

Another known approach is to functionalize fine silica particles with perfluorooctylethyltrichlorosilanes, and then suspend the functionalized silica in a UV-curable varnish (e.g., as described in JP 09-220518). When varnish matrix is cured, the resulting coatings provide PMMA intensified water repellent properties.

A simpler approach is to directly use of mixtures of perfluorohexylethylenetrimethoxysilane, its hydrolysis products, and acrylic monomers in a varnish. Coating and LW curing such a varnish provides polymer films which adhere well to a substrate and possess antifouling properties (e.g., as described in JP 10-104403).

However, a problem with coatings in general, is the effect on light transmission. Light transmission is often poor due to the reflections from the plurality of interfaces having different optical densities. In addition, when metal oxide particles are used, such particles readily scatter light. Moreover, the thickness of the coating may prevent the effective coating of fine textured surfaces due to the wetting problems already described. Finally, the lack of elasticity and toughness in such coatings may also have deleterious effects.

The interface chemistry of a surface may be influenced by modifying only the upper atomic layers of the interface. In other words, very thin organofluorine layers are sufficient. The use of low pressure plasmas as a method of generating thin coatings is known from the literature. One possible coating process is that of plasma polymerizing perfluorocycloalkanes, to provide substrates with a thin coating of perfluoroalkanes (i.e., EP 0 590 007). Coatings may also be provided by the plasma polymerization of vinylmethylsilanes or vinyltrimethoxysilanes. When such materials are polymerized, polymers having lateral silane or siloxane branches are formed which may be used to coat a variety of substrates. The coatings have a roughness of from 100 to 200 nm and contact angles for water of approximately 140° (e.g., as described in DE 195 43 133). However, because low pressure plasma polymerization requires a large and complex apparatus, and the process itself is time consuming, low pressure plasma polymerization has been used much less to date than wet chemical processes for providing coatings.

Plasmas and other physical processes have also long been used to prepare polyolefin surfaces for coating by generating binding sites for attaching the coating to the substrate. In addition, other physical processes may be employed for this purpose, and have become established in the plastics coating art. For example, JP 04-326965, supra, describes pretreating a PC sheet by exposing it to UV light prior to treatment with 3-aminopropyltrimethoxysilane.

EP 0 846 717, EP 0 846 716 and EP 0 846 715 disclose, inter alia, wet chemical processes which comprise coating plastics with thin layers of polysiloxane, e.g., alcohol or water based fluoroalkyl-functional organopolysiloxane compositions. Surface adhesion of the coating is achieved in one step by the silane and siloxane groups, and the desired interface properties are imparted of the by the fluoroalkyl groups. This process is extremely simple, and it is unnecessary to apply the coating material beforehand.

It is also known (P. K. Jenkner; Thin Film Fluorosilane Coatings; Fluorine in Coatings III; 1999; ISBN 09505319960) that this kind of coating provides film thicknesses of only 2 to 3 nm. Accordingly, one can obtain coated substrates with optimum transparency and no impairment of surface textures. In particular, these properties can be achieved when the substrates are immersion coated and the polysiloxane layer forms by self-organization.

It is therefore an object of the present invention to provide a simple method of surface modifying polymeric materials, to provide hydrophobic and oleophobic coatings of extremely high quality. In particular, coatings prepared by this method are resistant to hydrolysis and provide improved resistance to abrasion.

### SUMMARY OF THE INVENTION

Accordingly, it is an object of the present invention to provide a method of coating a polymeric substrate, in which the polymeric substrate is first pretreated by application of at least one physical method, for example corona discharge, flaming, glow discharge, irradiation with electromagnetic waves, and/or plasma pretreatment, then coating the pretreated polymeric substrate with a composition comprising a fluoroalkyl-containing silicon compound. It has surprisingly been found that it is advantageous to subject polymeric substrates to such pretreatment prior to contacting the substrate surface with an alcohol or water based fluoroalkyl-functional silane or fluoroalkyl-functional organopolysiloxane composition. As a result of such physical pretreatment processes, it is possible to dispense with coating the substrates with a tie coat, or adding other binding promoters, such as metal oxides.

### BRIEF DESCRIPTION OF THE DRAWINGS

FIG. 1 is a plot of the advancing water contact angle of a PPMA substrate, either coated according to the method of the present invention with reaction solution 2a (DSF 8262), uncoated, or treated with reaction solution 2a without pretreatment, as a function of the number of abrasion cycles.

FIG. 2 is a plot of the advancing water contact angle of a PC substrate, coated according to the method of the present invention with reaction solution 2a (DSF 8262), uncoated, or treated with reaction solution 2a without pretreatment, as a function of the number of abrasion cycles.

FIG. 3 is a plot of the advancing water contact angle of a PPMA substrate, coated according to the method of the present invention with reaction solution 4a (DSF 8810), uncoated, or treated with reaction solution 4a without pretreatment, as a function of the number of abrasion cycles.

FIG. 4 is a plot of the advancing water contact angle of a PC substrate, coated according to the method of the present invention with reaction solution 4a (DSF 8810), uncoated, or treated with reaction solution 4a without pretreatment, as a function of the number of abrasion cycles.

### DETAILED DESCRIPTION OF THE INVENTION

Examples of physical pretreatment methods which may be used on polymeric substrates include direct current and low frequency glow discharge, high frequency glow discharge, non-self-sustaining glow discharge, corona discharge, flaming, electromagnetic radiation, microwave discharge/ECR plasmas and low pressure plasma. Corona processes are closely related to glow discharge process or arc discharge processes. A corona discharge forms when a very non-homogeneous electrical field is formed in front of a metallic electrode, having a special geometry, such as a pointed shape.

Flame discharges are plasma sources with arc or HF discharges as the energy source, which are superimposed on a plasma by gas flows, and are utilized outside of the plasma unit. In this regard, there are different structural forms, which are described in detail in “Wissensspeicher Plasmatechnik,” 1^{st} edition, VEB Verlag, 1983, incorporated herein by reference, at page 234. Process parameters and work gases are described at page 236.

Glow discharges are generated by transfer of power from an electric field to electrons. The mechanism of accomplishing this transfer will depend on the frequency of the field activating the glow discharge. Reactor geometries and plasma parameters are described in detail in “Plasma Deposition, Treatment, and Etching of Polymers,” Academic Press Inc., edited by Riccardo d'Agostino, incorporated herein by reference, at page 10.

These pretreatments are preferably conducted in an air, nitrogen and/or argon atmosphere, and in particular under reduced pressure, preferably at a pressure of from 0.001 mbar to 0.99 bar absolute, inclusive of all values and subranges therebetween. For example, the pressure may include values of 0.01, 0.1, 1.0, 10, 20, 30, 40, 50, 60, 70, 80, 90, 100, 150, 200, 250, 300, 350, 400, 450, 500, 550, 600, 650, 700, 750, 800, 850, and 900 mbar absolute. Particularly preferably, the physical treatment comprises exposing the polymeric substrate to a plasma treatment at a pressure of from 0.002 mbar to 0.1 bar absolute, inclusive of all values and subranges therebetween. For example, the pressure may include values of 0.01, 0.02, 0.03, 0.04, 0.05, 0.06, 0.07, 0.08, and 0.09 mbar absolute Examples of a suitable plasma source include a low pressure plasma, a direct current low frequency glow discharge, a direct current high frequency glow discharge, a microwave/ECR plasma, a non-self-sustaining glow discharge, a corona discharge and/or flaming. A preferred pretreatment is to combine microwave plasma or corona plasma with a methane gas flame.

Another preferred method of physically pretreating a plastic substrate is to expose the plastic substrate to UV radiation at wavelengths of from 10 to 400 nm, in particular from 150 to 350 nm, inclusive of all values and subranges therebetween. UV radiation with wavelengths of 308 or 172 nm using an excimer lamp (e.g. from Heraeus Noblelight) and a vacuum of <10 mbar is particularly preferred. Likewise, low pressure plasmas (e.g., in an instrument from Europlasma, ignited at 13.56 kHz, 600 W) of inert gases are also preferred methods of pretreating polymeric substrates. If low pressure plasmas of inert gases are used, it is particularly preferred that the plasma be conducted under a constant air, nitrogen and/or argon stream, at a pressure of, for example, about 16.5 mbar. In each case, the pretreatment of the substrate surface, especially for irradiation, is carried out for from 5 seconds to 30 minutes, inclusive of all values and subranges therebetween, preferably from 10 seconds to 5 minutes, particularly preferably from 1 to 2 minutes. In addition, the treatment time may be 6, 7, 8, 9, 10, 15, 20, 25, 30, 35, 40, 45, 50, 55, and 60 seconds, and 2, 3, 4, 5, 6, 7, 8, 9, 10, 15, 20, and 25 minutes.

The process of the present invention may be used to treat virtually any common plastic material surface, e.g., polymeric substrates comprising homopolymers, copolymers, and polymer alloys, heterogeneous mixtures of different plastics, or plastics with insoluble constituents, such as pigments or fillers. Thin polymer coatings and other materials, such as laminates or surface coating materials, may also be considered substrates according to the present invention. The substrates of the present invention may consist in whole or in part of a polyamide, a polyimide, a polyester, a polycarbonate, a polyurethane, a polysulfone, and other polycondensation polymers. In addition, the polymeric substrate may also consist in whole or in part of polyolefins, such as polyethylene and polypropylene, polymers of acrylic, methacrylic and other vinyl compounds, such as polymethyl methacrylate, polyethers, polyamines, polystyrene, polyoxymethylene and other addition polymers, and also phenolic resins, melamine resins and epoxy resins. The polymeric substrate may be a thermoplastic, thermosetting or elastomeric material.

Following the pretreatment, the polymeric substrate is coated with a composition comprising a fluoroalkyl-functional alkoxysilane or silanol, concentrated or dissolved or diluted, as disclosed for example in EP 1 033 395, incorporated in its entirety herein by reference, or a alcohol, water/alcohol, or alcohol based fluoroalkyl-functional organopolysiloxane composition. Such fluoroalkyl-functional organopolysiloxane compositions are disclosed in particular by U.S. Pat. Nos. 6,251,989, 5,808,125, 5,849,942, and 6,177,582, each of which is incorporated in its entirety by reference. For example, suitable fluoroalkyl-functional organopolysiloxanes may comprise the condensation products of fluoro-functional organosilanes with other organosilanes, such as amino-functional organosilanes, alkyl-functional organosilanes, etc. The fluoro-functional organosilanes may include, for example 3,3,3-trifluoropropyl trimethoxy silane, 3,3,3-trifluoropropyl methyl dimethoxy silane, 3,3,3-trifluoropropyl methyl dimethoxy silane, 3,3,3-trifluoropropyl cyclohexyl dimethoxy silane, 3,3,3-trifluoropropyl phenyl diethoxy silane, 3,3,3-trifluoropropyl triethoxy silane, 3,3,3,2,2-pentafluoropropyl methyl dimethoxy silane, 3,3,3-trifluoropropyloxyethyl trimethoxy silane, 3,3,3-trifluoropropyl mercaptoethyl trimethoxy silane, 3,3,3-trifluoropropyloxyethyl methyl dimethoxy silane, as well as, in particular, tridecafluoro-1,1,2,2-tetrahydrooctyl trimethoxy silane, and tridecafluoro-1,1,2,2-tetrahydrooctyl triethoxy silane. The alkyl-functional organosilanes may be alkyl substituted alkoxysilanes, such as dimethyldimethoxysilane, dimethyldiethoxysilane, propylmethyldimethoxysilane, propylmethyldiethoxysilane propyltrimethoxysilane, propyltriethoxysilane, isobutyltrimethoxysilane, isobutyltriethoxysilane, and octyltrimethoxysilane, octyltriethoxysilane. In addition, the fluoro-functional organosilane may be an aminosilane, such as aminopropyltriethoxysilane, β-aminoethyl trimethoxy silane, β-aminoethyl triphenoxy silane, β-aminoethyl methyl dimethoxy silane, β-aminoethyl phenyl dimethoxy silane, β-aminoethyl trimethoxy silane, β-aminoethyl methyl dimethoxy silane, β-aminoethyl triethoxy silane, (β-aminoethylamino)-n-propyl ethyl triethoxy silane, (β-aminoethylamino)-propyl triethoxy silane, (β-aminoethylamino)-n-propyl methyl dimethoxy silane, Ω-amino-n-hexyltriethoxy silane, Ω-amino-n-hexyl trimethoxy silane, Ω-amino-n-hexyl methyl dimethoxy silane, γ-amino-n-propyl trimethoxy silane, γ-amino-n-propyl methyl dimethoxy silane, γ-amino-n-propyl triethoxy silane, and γ-amino-n-propyl methyl diethoxy silane. The condensation of the fluoro-functional silane and other organosilanes is typically carried out in the presence of a acid catalyst.

Treating the pretreated substrate with an organosilicon compound may be carried out, for example, simply by immersing the pretreated polymeric substrate into the coating composition. The pretreated substrate may be contacted with the composition for from 1 to 60 minutes, preferably from 5 to 60 minutes, inclusive of all values and subranges therebetween (i.e., 2, 3, 4, 5, 6, 7, 8, 9, 10, 15, 20, 25, 30, 35, 40, 45, 50, and 55 minutes). In addition, the composition may be rubbed into the substrate at the same time, if desired. Absorbent polymeric materials, such as a sponge or cloth, may also be impregnated with the composition. By this means it is also possible to rub in the composition onto a polymeric substrate's dry surface, pretreated according to the present invention. Another way of coating the composition onto the polymeric substrate, especially a fluoroalkyl-functional organopolysiloxane composition, is by any conventional spraying process,.

Following the application of the fluoroalkyl-functional compositions to the pretreated polymeric substrate, the coated substrate may be heat treated, preferably at from 80 to 150° C. for from 5 to 150 minutes, inclusive of all values and subranges therebetween. For example, the temperature may be 90, 100, 110, 120, 130, and 140C, and the heat treatment time may be 10, 15, 20, 25, 30, 35, 40, 45, 50, 55, 60, 65, 70, 75, 80, 85,90, 95, 100, 105, 110, 115, 120,125, 130, 135, 140, and 145 minutes. Plastics having a glass transition point of from 100 to 150° C. are preferably heat treated at 80° C. for 60 minutes; plastics having a glass transition point of >150° C., are preferably heated at 120° C. for 30 minutes.

In general, the method of the present invention is carried out by subjecting a polymeric substrate having a generally clean, dry and grease-free surface to corona discharge, flaming, glow discharge, specific electromagnetic waves (e.g., UV) and/or a plasma. This mode of pretreatment of the substrate surface may be conducted in an air, nitrogen and/or argon atmosphere. Following the pretreatment of the substrate surface, the composition comprising a fluoroalkyl-functional silicon compound is applied. The substrate thus surface pretreated and coated with a fluoroalkyl-functional silicon compound may be optionally subsequently dried and additionally thermally post-treated.

Layers or coatings on polymeric substrates provided by the method of the present invention have hydrophobic, oleophobic and dirt repellent properties, and are notable for an above average level of quality, in particular, excellent transparency and resistance to abrasion and to weathering.

In a second embodiment, the present invention further provides oil, water and dirt repellent coatings or layers on a polymeric substrate, a polymeric substrate so coated, and also polymeric articles having an oil, water and dirt repellent coating which are obtained by the method of the present invention.

Coatings provided by the method of the present invention exhibit excellent transparency, and furthermore have excellent oil, water and dirt repellent properties. The water contact angle of such coatings is outstandingly high, for example, the coatings according to the present invention may have an advancing contact angle of 110 to 130°. Polymeric substrates, pretreated and coated according to the method of the present invention, which are boiled in DI water for 3 hours also show a lower loss of coating material due to hydrolysis than do essentially identical polymeric substrates which have been coated, but not pretreated, according to the present invention. If polymeric substrates, pretreated and coated according to the method of the present invention are wiped, under controlled conditions (i.e., number and pressure of wipes) using a polyethylene terephthalate (PET) nonwoven material, a lower loss of coating material due to abrasion is observed compared to essentially identical substrates which have not been pretreated. In addition, both the “boiled” and “wiped” coated substrates of the present invention exhibit higher water contact angles than do the corresponding coated substrates which were not pretreated. Consequently, coated substrates prepared by the method of the present invention have substantially higher quality (i.e., more hydrophobic, abrasion resistant, etc.) compared to coated substrates which were not pretreated.

As a third embodiment, the present invention provides for a method of protecting plastic parts, injection moldings, films, textiles, etc. from exposure to water, hydrophobic materials such as oils, greases, etc., dirt, and weathering (i.e., photodegradation and oxidative degradation) by coating the plastic parts, etc., according to the method of the present invention. In other words, plastic articles for which such protection is desired may be physically pretreated and coated with a composition comprising a fluoroalkyl-containing silicon compound, then optionally dried and/or heat treated.

Having generally described this invention, a further understanding can be obtained by reference to certain specific examples which are provided herein for purposes of illustration only, and are not intended to be limiting unless otherwise specified.

### EXAMPLES

| | |
|---|---|
| Abbreviations: | |
| RT | Room temperature |
| PET | Poly(ethylene terephthalate) |
| Substrate materials: | |
| PC | Polycarbonate (Makrolon) |
| PMMA | Polymethyl methacrylate |
| POM | Polyoxymethylene |
| PP | Polypropylene |

DYNASYLAN® compounds used:

DYNASYLAN® F 8261 Tridecafluoro-1,1,2,2-tetrahydrooctyl-1-triethoxysilane

DYNASYLAN® F 8850 3,3,4,4,5,5,6,6,7,7,8,8,8-tridecafluorooctyltriethoxyoligosiloxane, prepared by HCl catalyzed condensation of 3,3,4,4,5,5,6,6,7,7,8,8,8-tridecafluorooctyltriethoxy-silane with 0.8 mol/mol H₂O (dimers, trimers, tetramers), 50% by weight in ethanol

DYNASYLAN® F 8262 alcoholic solution of activated fluoroalkyl-functional organosilane, analogous to example C/5a, DE 199 04 132 or EP 1 033 395 (Jenkner et al., Degussa-Hüls A G). For DYNASYLAN® F 8262, ethanol is used instead of isopropanol. Composition: 1.0% by weight 3,3,4,4,5,5,6,6,7,7,8,8,8-tridecafluorooctyltriethoxysilane, 0.126% by weight H₂O, 0.074% by weight HCl (absolute), 0.1% by weight SnCl₂X2H₂O, 98.7% by weight ethanol.

DYNASYLAN® F 8810 10% by weight aqueous solution of an oligomerized cocondensate of 3,3,4,4,5,5,6,6,7,7,8,8,8-tridecafluorooctyltriethoxysilane and 3-aminopropyltriethoxysilane, analogous to example H2, DE 198 23 390 (Standke et al., Degussa-Hüls A G)

1. Preparation of DYNASYLAN® F 8261 Coating Solution

DYNASYLAN® F 8261 is dissolved in 97.7 g of absolute ethanol with stirring. Then 0.2 g of hydrochloric acid (37%), 1 g of water and 0.1 g of SnCl₂ hydrate are added to this solution in succession, and stirring is continued at RT for at least 12 to 24 hours. The silane unit:HCl:water molar ratio is 1:1:28.

2. Preparation of DYNASYLAN® F 8262 Coating Solution

A. DYNASYLAN® F 8262 solution is used as supplied.

B. DYNASYLAN® F 8262 solution is mixed with 0.1% of SnCl₂ hydrate and stirred at RT for at least 12 to 24 hours.

3 . Preparation of DYNASYLAN® F 8850 Coating Solution

VPS 8850 is dissolved with stirring in 97.7 g of absolute ethanol. Then 0.2 g of hydrochloric acid (37%), 1 g of water and 0.1g of SnCl₂ hydrate are added in succession, and stirring is continued at RT for at least 12 to 24 hours. After about 1 to 2 hours the reaction mixture is homogeneous.

4. Preparation of DYNASYLAN® F 8810 Coating Solution

A. DYNASYLAN® F 8810 solution is used as supplied.

B. 20 g of DYNASYLAN® F 8810 solution is added with stirring to 100 g of DI water. The reaction mixture is acidified to pH 1.5 (with monitoring using a pH electrode) using HCl (37%) and stirred at RT for 12 to 24 hours.

### Example 1

Sample plates of PMMA, PC, POM or PP were inserted into a vacuum chamber and exposed to a vacuum of at least 1 mbar. Under these conditions the samples were exposed for 2 minutes at 172 nm using an excimer lamp (from Heraeus Noblelight) and after 5 minutes the vacuum was removed and the samples were placed into one of the above-described coating solutions (i.e., 1, 2a, 2b, 3, 4a, or 4b) in a photographic tray for 60 minutes. Samples that had not been so pretreated were likewise coated. The samples were removed from the solutions, blown dry with clean, compressed air and heated at 80° C. for 60 minutes. Subsequently, the advancing contact angles for water were measured. The samples were then subjected to extraction in boiling water for 3 hours, and the advancing contact angles for water were again measured. The results are shown in Table 1, infra.

TABLE 1
Results for Example 1

| | | | | Advancing angle |
|---|---|---|---|---|
| | | Reaction solution | Advancing angle | after 3 h boiling |
| Substrate material | Activation | [product] | [°] | [°] |
| PMMA | — | — | 87.8 | — |
| PC | — | — | 86.9 | — |
| POM | — | — | 83.2 | — |
| PP | — | — | 92.8 | — |
| PC | — | 1,[DSF 8261] | 113.3 | 98.9 |
| PC | UV | 1,[DSF 8261] | 120.1 | 110.1 |
| PMMA | — | 2b,[DSF 8262] | 105.7 | 94 |
| PMMA | UV | 2b,[DSF 8262] | 92.2 | 110.6 |
| PP | — | 1,[DSF 8261] | 120.8 | 106.2 |
| PP | UV | 1,[DSF 8261] | 117.5 | 118.7 |
| PC | — | 4b,[DSF 8810] | 127.4 | 100.9 |
| PC | UV | 4b,[DSF 8810] | 124.7 | 121.9 |
| PMMA | — | 4b,[DSF 8810] | 121.0 | 109.1 |
| PMMA | UV | 4b,[DSF 8810] | 125.1 | 118.9 |
| PC | — | 3,[DSF 8850] | 116.4 | 90.4 |
| PC | UV | 3,[DSF 8850] | 120.5 | 105.0 |
| POM | — | 3,[DSF 8850] | 107.1 | 77.9 |
| POM | UV | 3,[DSF 8850] | 123.3 | 111.9 |
| PP | — | 3,[DSF 8850] | 109.5 | 107.6 |
| PP | UV | 3,[DSF 8850] | 119.5 | 125.3 |

### Example 2

Plates of PMMA, PC or PP were inserted into the vacuum chamber of a plasma unit (e.g., from Europlasma) and subjected to a vacuum of 16.5 mbar under a constant gas stream of nitrogen, air or argon. A plasma was ignited (13.56 kHz, 600 W) and the samples were treated for 2 minutes. After a further 5 minutes, the pressure was increased to atmospheric pressure with nitrogen and the samples were removed. Over the course of 6 hours the samples were placed in the above-described coating solutions in a photographic tray, together with samples which had not been pretreated. The samples were immersed in the coating solutions for approximately 60 minutes. The samples were removed from the solution, blown dry with clean, compressed air and heated at 80° C. for 60 minutes. Subsequently the advancing contact angles for water and hexadecane were measured, the samples were subjected to extraction in boiling water for 3 hours, and the advancing contact angles for water and hexadecane were again measured. The results are shown in Table 2, infra.

TABLE 2
Results for Example 2

| | | | | | Hexadecane | |
|---|---|---|---|---|---|---|
| | | | Advancing angles | | | After |
| | Activ- | Reaction | | after 3 h | | 3 h |
| Substrate | ation | solution | Water | boiling | | boiling |
| material | (gas) | (product) | [°] | [°] | [°] | [°] |
| PMMA | — | — | 87.9 | — | 13 | — |
| PC | — | — | 86.9 | — | 11 | — |
| PP | — | — | 92.8 | — | <10 | — |
| PMMA | — | 2b,[DSF 8262] | 105.7 | 94.0 | | — |
| PMMA | plasma | 2b,[DSF 8262] | 120.7 | 102.8 | 82.6 | — |
| | [air] | | | | | |
| PMMA | plasma | 2b,[DSF 8262] | 104.8 | 109.8 | 73.6 | — |
| | [N₂] | | | | | |
| PC | — | 2b,[DSF 8262] | 113.3 | 98.9 | — | — |
| PC | plasma | 2b,[DSF 8262] | 117.6 | 116.1 | — | 62.5 |
| | [air] | | | | | |
| PC | plasma | 2b,[DSF 8262] | 116.0 | 116.6 | — | 50.7 |
| | [N₂] | | | | | |
| PC | plasma | 2b,[DSF 8262] | 113.5 | 116.7 | — | — |
| | [AR] | | | | | |
| PP | — | 2a,[DSF 8262] | 87.6 | 105.5 | — | — |
| PP | plasma | 2a,[DSF 8262] | 88.1 | 101.7 | — | 61.0 |
| | [N₂] | | | | | |
| PP | — | 2b,[DSF 8262] | 85.1 | 112.6 | — | — |
| PP | plasma | 2b,[DSF 8262] | 113.7 | 107.1 | — | 59.3 |
| | [N₂] | | | | | |
| PMMA | — | 4b,[DSF 8810] | 121.0 | 109.1 | — | — |
| PMMA | plasma | 4b,[DSF 8810] | 127.0 | 110.0 | — | 64.7 |
| | [air] | | | | | |
| PMMA | plasma | 4b,[DSF 8810] | 125.6 | 123.4 | — | 68.4 |
| | [N₂] | | | | | |
| PC | — | 4b,[DSF 8810] | 127.4 | 100.9 | — | — |
| PC | plasma | 4b,[DSF 8810] | 118.8 | 120.8 | — | 71.8 |
| [Air] | | | | | | |
| PC | plasma | 4b,[DSF 8810] | 125.8 | 123.4 | — | 68.9 |
| | [air] | | | | | |
| PC | plasma | 4b,[DSF 8810] | 121.5 | 119.5 | — | — |
| | [N₂] | | | | | |
| PP | — | 4a,[DSF 8810] | 116.7 | 104.3 | — | — |
| PP | plasma | 4a,[DSF 8810] | 126.8 | 118.1 | — | — |
| | [N₂] | | | | | |
| PP | — | 4b,[DSF 8810] | 82.4 | 106.6 | — | — |
| PP | plasma | 4b,[DSF 8810] | 106.3 | 117.3 | — | — |
| | [N₂] | | | | | |
| PC | — | 3,[DSF 8850] | 116.4 | 90.4 | — | — |
| PC | Plasma | 3,[DSF 8850] | 120.7 | 117.6 | — | 60.3 |
| | [Ar] | | | | | |

### Example 3

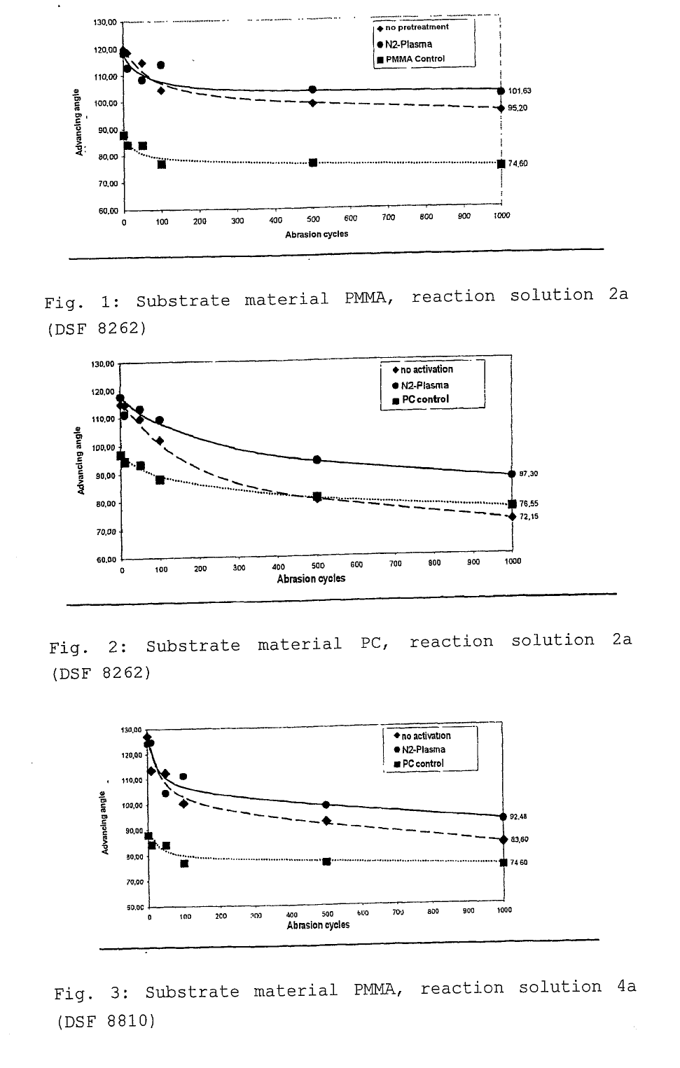

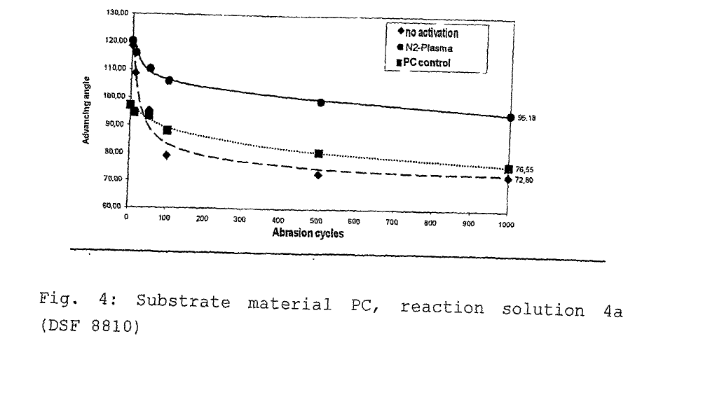

Samples of PC and PMMA were treated as in Example 2, supra. The advancing contact angles for water were measured, and then the samples were subdivided and abraded as follows. In one abrasion cycle the sample was pressed against a PET nonwoven (250 g/m²) with an applied weight of 100 g/cm² and moved a distance of 10 cm thereon. Advancing contact angles were then measured after various numbers of cycles. The results are shown in FIGS. 1-4. As shown in the figures, coated samples (both pretreated and not pretreated) initially have higher advancing contact angles than control samples which were not coated or pretreated. For example, in FIG. 1 the initial advancing contact angle for coated PMMA was 110-120, whereas the advancing contact angle for the untreated PMMA control was 80-90. After 1000 abrasion cycles, however, the advancing contact angles of the coated and pretreated PMMA, coated but not pretreated PMMA, and uncoated and not pretreated PMMA were, respectively, 101.63, 95.20, and 74.60. Thus, samples which were pretreated and coated according to the method of the present invention, retain better surface properties than do samples which were not pretreated.

The priority document of the present application, German application 10100383.8, filed Jan. 5, 2001, is incorporated herein by reference.

Obviously, numerous modifications and variations on the present invention are possible in light of the above teachings. It is therefore to be understood that within the scope of the appended claims, the invention may be practiced otherwise than as specifically described herein.

What is claimed as new and is intended to be secured by Letters Patent is:

1. A method of coating a polymeric substrate comprising:
pretreating the substrate by application of at least one physical method selected from the group consisting of corona discharge, flaming, glow discharge, irradiation with electromagnetic waves, and a plasma pretreatment; then
coating said pretreated substrate with a composition comprising a fluoroalkyl-containing silicon compound.

2. The method of claim 1, wherein said pretreating is carried out under reduced pressure in an atmosphere selected from the group consisting of air, nitrogen, argon, and mixtures thereof.

3. The method of claim 2, wherein said reduced pressure is from 0.001 mbar to 0.99 bar absolute.

4. The method of claim 1, wherein said pretreating is a plasma treatment carried out at a pressure of from 0.002 mbar to 0.1 bar absolute.

5. The method of claim 1, wherein the substrate surface is exposed to light with a wavelength of from 10 to 400 nm.

6. The method of claim 5, wherein the wavelength is 150 to 350 nm.

7. The method of claim 1, wherein said pretreating is carried out for from 5 seconds to 30 minutes.

8. The method of claim 7, wherein said pretreating is carried out for from 10 seconds to 5 minutes.

9. The method of claim 1, wherein said pretreating is a low pressure plasma, a direct current low frequency glow discharge, a direct current high frequency glow discharge, a microwave/ECR plasma, a non-self-sustaining glow discharge, a corona discharge, flaming, and combinations thereof.

10. The method of claim 1, wherein the polymeric substrate comprises at least one polymer selected from the group consisting of polymers of acrylic, methacrylic or vinyl compounds, polymers comprising phenolic resins, melamine resins and epoxy resins, polycarbonate, polyolefins, polyethers, polyoxymethylene, polystyrene, polyamine, polyamide, polyimide, polyurethane, polysulfone, and polyester.

11. The method of claim 1, wherein the fluoroalkyl-containing silicon compound is selected from the group consisting of a fluoroalkyl-containing monomeric alkoxysilane, a fluoroalkyl-containing monomeric silanol, a fluoroalkyl-containing siloxane, and the substrate surface thus treated is optionally dried and/or thermally post-treated.

12. The method of claim 1, further comprising heat treating said coated substrate after said coating.

13. The method of claim 12, wherein the heat treatment is carried out at a temperature of 80 to 150° C. for from 5 to 150 minutes.

14. A coating on a polymeric substrate, made by the process of claim 1.

15. A polymeric substrate coated by the process of claim 1.

16. The coated polymeric substrate of claim 15, wherein the polymeric substrate is selected from the group consisting of an injection molding, a film, and a textile.

17. A method of protecting a plastic substrate comprising:
pretreating the substrate by application of at least one physical method selected from the group consisting of corona discharge, flaming, glow discharge, irradiation with electromagnetic waves, and a plasma pretreatment; then
coating said pretreated substrate with a composition comprising a fluoroalkyl-containing silicon compound.
